(19) United States
(12) Patent Application Publication
(10) Pub. No.: US 2026/0133826 A1
(43) Pub. Date: May 14, 2026

(54) API SCHEDULING MANAGEMENT SYSTEM AND METHOD THEREOF

(71) Applicant: Quanta Computer Inc., Taoyuan City (TW)

(72) Inventors: Chun-Chieh MAO, Taoyuan City (TW); Huan-Ting CHEN, Taoyuan City (TW); Mao-Tien KUNG, Taoyuan City (TW); Meng-Yu LI, Taoyuan City (TW); Chun-Hung CHEN, Taoyuan City (TW); Chen-Chung LEE, Taoyuan City (TW)

(21) Appl. No.: 19/019,929

(22) Filed: Jan. 14, 2025

(30) Foreign Application Priority Data
Nov. 14, 2024 (TW) 113143755

(51) Int. Cl. G06F 9/48; G06F 9/54

(52) U.S. Cl. CPC G06F 9/4881; G06F 9/54

(57) ABSTRACT

An API scheduling management system is provided, which includes an in-memory database, a relational database, a front-end interface module, a job execution module, and an automated management module. The front-end interface module receives API scheduling settings corresponding to API jobs from a user interface and synchronizes the API scheduling settings to the in-memory database and the relational database. The job execution module executes corresponding API jobs according to the API scheduling settings in the in-memory database. The automated management module checks whether the API scheduling settings in the in-memory database and the relational database are consistent. In response to detecting an inconsistency between the API scheduling settings in the in-memory database and the relational database, the automated management module disables the job execution module, aligns the API scheduling settings between the in-memory database and the relational database, and enables the job execution module.

### CROSS REFERENCE TO RELATED APPLICATIONS

This Application claims priority of Taiwan Patent Application No. 113143755, filed on Nov. 14, 2024, the entirety of which is incorporated by reference herein.

### BACKGROUND OF THE INVENTION

### Field of the Invention

The present disclosure relates to scheduling management, and, in particular, to an API scheduling management system and method thereof.

### Description of the Related Art

With the widespread use of application programming interfaces (APIs) in modern computing environments, effectively managing and monitoring the execution of APIs has become critically important.

Existing scheduling management systems, such as Windows Task Scheduler or Linux crontab, are insufficient for effectively monitoring whether the execution of API jobs is successful. As a result, abnormal conditions cannot be detected in a timely manner. System administrators often become aware of such abnormalities only after they persist for several days, delaying corrective actions.

Therefore, there is a need for an API scheduling management system and method thereof that can address the aforementioned issues.

### BRIEF SUMMARY OF THE INVENTION

An embodiment of the present disclosure provides an application programming interface (API) scheduling management system, which includes an in-memory database, a relational database, a front-end interface module, a job execution module, and an automated management module. The front-end interface module is configured to receive API scheduling settings corresponding to API jobs from a user interface and to synchronize the API scheduling settings to the in-memory database and the relational database. The job execution module is configured to execute corresponding API jobs according to the API scheduling settings in the in-memory database. The automated management module is configured to check whether the API scheduling settings in the in-memory database and the relational database are consistent. In response to detecting an inconsistency between the API scheduling settings in the in-memory database and the relational database, the automated management module is further configured to disable the job execution module, align the API scheduling settings between the in-memory database and the relational database, and enable the job execution module.

In an embodiment, the relational database is configured to store the API scheduling settings through an API table and a scheduling table that are associated with each other. The in-memory database is configured to store the API scheduling settings using key-value pairs. Each of the key-value pairs includes an index key. The automated management module is configured to check whether the API scheduling settings in the in-memory database and the relational database are consistent by comparing the scheduling table with the index keys.

In an embodiment, the scheduling table is used to store scheduling data corresponding to the one or more API jobs. Additionally, the index keys further include the scheduling data corresponding to the one or more API jobs.

In an embodiment, the automated management module is further configured to compare the number of the index keys with the data count of the scheduling data stored in the scheduling table. In response to detecting that the number of the index keys is less than the data count of the scheduling data stored in the scheduling table, the automated management module is further configured to disable the job execution module, synchronize to the in-memory database a portion of the API scheduling settings that is missing from the in-memory database relative to the relational database, and enable the job execution module. In response to detecting that the number of the index keys are greater than the data count of the scheduling data stored in the scheduling table, the automated management module is further configured to disable the job execution module, delete from the in-memory database a portion of the API scheduling settings that is excess in the in-memory database relative to the relational database, and enable the job execution module.

In an embodiment, in response to detecting that the quantity of the index keys is equal to the data count of scheduling data stored in the scheduling table, the automated management module is further configured to verify whether the scheduling data included in the index keys matches the scheduling data stored in the scheduling table. In response to detecting that the scheduling data included in the index keys does not match the scheduling data stored in the scheduling table, the automated management module is further configured to disable the job execution module, synchronize the API scheduling settings from the relational database to the in-memory database, and enable the job execution module.

In an embodiment, in response to detecting that the scheduling data included in the index keys does not match the scheduling data stored in the scheduling table, the automated management module is further configured to send an alert notification to the system administrator.

In an embodiment, the API scheduling management system further includes a document database. The job execution module is further configured to store execution logs generated by executing the API jobs in the document database. The automated management module is further configured to check for a timeout error from the execution logs. The automated management module is further configured to issue a request to the API job corresponding to the timeout error to determine whether a notification recipient is either the user or the system administrator, in response to detecting the timeout error. The automated management module is further configured to send an alert notification to the notification recipient, and restart the job execution module.

In an embodiment, the document database is implemented using MongoDB.

In an embodiment, the in-memory database is implemented using Redis.

In an embodiment, the relational database is implemented using Microsoft SQL Server.

An embodiment of the present disclosure provides a method for API scheduling management. The method includes, by a front-end interface module, receiving API scheduling settings corresponding to one or more API jobs from a user interface, and synchronizing the API scheduling settings to an in-memory database and a relational database. The method further includes, by a job execution module, executing the corresponding API jobs according to the API scheduling settings stored in the in-memory database. The method further includes, by an automated management module, checking whether the API scheduling settings in the in-memory database and the relational database are consistent. The method further includes, by the automated management module, in response to detecting an inconsistency between the API scheduling settings in the in-memory database and the relational database, disabling the job execution module, aligning the API scheduling settings between the in-memory database and the relational database, and enabling the job execution module.

The API scheduling management solution provided by the embodiments of the present disclosure achieves automated anomaly monitoring and recovery. This not only reduces the need for manual intervention but also ensures the robustness of API workflows.

### BRIEF DESCRIPTION OF THE DRAWINGS

The present invention can be more fully understood by reading the subsequent detailed description and examples with references made to the accompanying drawings, wherein:

FIG. 1 is a system architecture diagram of an API scheduling management system, according to an embodiment of the present disclosure;

FIG. 2 is a flow diagram of an API scheduling management method, according to an embodiment of the present disclosure;

FIG. 3 is a flow diagram of an automated monitoring and recovery method implemented by the automated management module, according to an embodiment of the present disclosure;

FIG. 4 illustrates additional steps of the automated monitoring and recovery method executed by the automated management module, according to a further embodiment of the present disclosure; and

FIG. 5 is a flow diagram of an automated monitoring and recovery method implemented by the automated management module, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

In general, the present disclosure provides an API scheduling management system that offers a user interface for users to configure and maintain the required API services. The system executes corresponding API jobs according to the scheduling times set by the users and is capable of performing automated anomaly monitoring and recovery during the execution of the jobs.

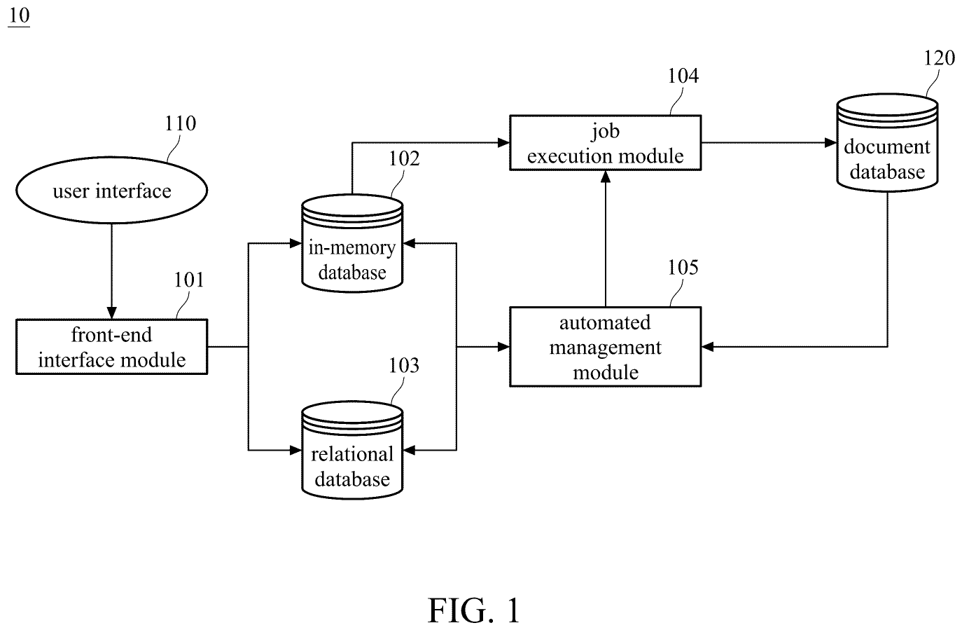

FIG. 1 is a system architecture diagram of an API scheduling management system 10, according to an embodiment of the present disclosure. As shown in FIG. 1, the API scheduling management system 10 at least includes a front-end interface module 101, an in-memory database 102, a relational database 103, a job execution module 104, and an automated management module 105. Optionally, the API scheduling management system 10 may further includes a document database 120.

The API scheduling management system 10 may be implemented as a standalone computer device (e.g., a server) or as a computer cluster composed of multiple computer devices operating collaboratively. The components depicted in FIG. 1, including the front-end interface module 101, the in-memory database 102, the relational database 103, the job execution module 104, the automated management module 105, and the document database 120, may all be implemented on a single computer device or distributed across two or more computer devices, but the present disclosure is not limited thereto.

Each of the aforementioned computer devices may include a processing unit and a storage unit. The storage unit may be any device that includes non-volatile memory (e.g., read-only memory (ROM), electrically-erasable programmable read-only memory (EEPROM), flash memory, or non-volatile random access memory (NVRAM)), such as hard disk drives (HDDs), solid-state drives (SSDs), or optical disks, but the present disclosure is not limited thereto. The processing unit may be any processor capable of executing instructions, such as a central processing unit (CPU) or a graphics processing unit (GPU). In addition, at least one computer device includes a display unit, such as a Liquid-Crystal Display (LCD) or an Organic Light-Emitting Diode (OLED) display, for presenting the user interface 110.

The API scheduling management method used by the API scheduling management system 10 of the present disclosure may be implemented by loading a program from the storage unit into the processing unit of one or more of the aforementioned computer devices. This program may be written in any one or more programming languages, such as Java, C, C #, C++, or Python, but the present disclosure is not limited thereto. The program includes instructions corresponding to the front-end interface module 101, the job execution module 104, and the automated management module 105. When executed by the processing unit, these instructions can implement the functionalities of the front-end interface module 101, the job execution module 104, and the automated management module 105.

The in-memory database 102 is a database specially designed for caching, primarily using main memory as its storage medium, and is intended to provide extremely high data access speeds and low-latency query performance. For instance, the in-memory database 102 may be implemented using Remote Dictionary Server (Redis), memcached, or Hazelcast, but the present disclosure is not limited thereto.

In various embodiments of the present disclosure, the in-memory database 102 is used to store and rapidly access API scheduling settings. In a preferred embodiment, the in-memory database 102 is implemented using Redis. One advantage of employing Redis in this embodiment lies in its support for master-replica replication. Specifically, data can be synchronized from a master server to any number of replica servers. A replica server can act as the master server for another replica server, thereby forming a single-rooted replication tree. Additionally, the publish-subscribe functionality enables clients of replica servers to subscribe to a channel and receive the complete stream of messages published to the master server, regardless of their position within the replication tree.

The relational database 103 is a database based on the relational model, structuring and managing data through tables and their relationships. For instance, the relational database 103 may be implemented using MySQL, PostgreSQL, or Microsoft SQL Server, but the present disclosure is not limited thereto.

In various embodiments of the present disclosure, the relational database 103 serves as a backend backup storage point for API scheduling settings and as a reference baseline for automated anomaly monitoring. In a preferred embodiment, the relational database 103 is implemented using Microsoft SQL Server. One advantage of employing Microsoft SQL Server in this embodiment lies in its support for Transparent Data Encryption (TDE) and auditing functionalities, which provide superior performance in terms of data security. Compared to other relational databases, Microsoft SQL Server also offers deeper integration with Microsoft's technological ecosystem (e.g., Azure cloud services), enabling seamless connections with cloud and on-premises resources to further enhance system scalability and flexibility.

The document database 120 is a document-oriented database capable of accommodating diverse and unstructured data formats. It is typically used for storing semi-structured or unstructured data. The document database 120 may be implemented using MongoDB, CouchDB, or Elasticsearch, but the present disclosure is not limited thereto.

In various embodiments of the present disclosure, the document database 120 is an optional component of the API scheduling management system 10, used for storing execution logs generated by executing API jobs. In a preferred embodiment, the document database 120 is implemented using MongoDB. One advantage of employing MongoDB in this embodiment lies in its support for flexible document structures and automatic sharding, enabling efficient data access and scalability even when the volume of log data grows rapidly.

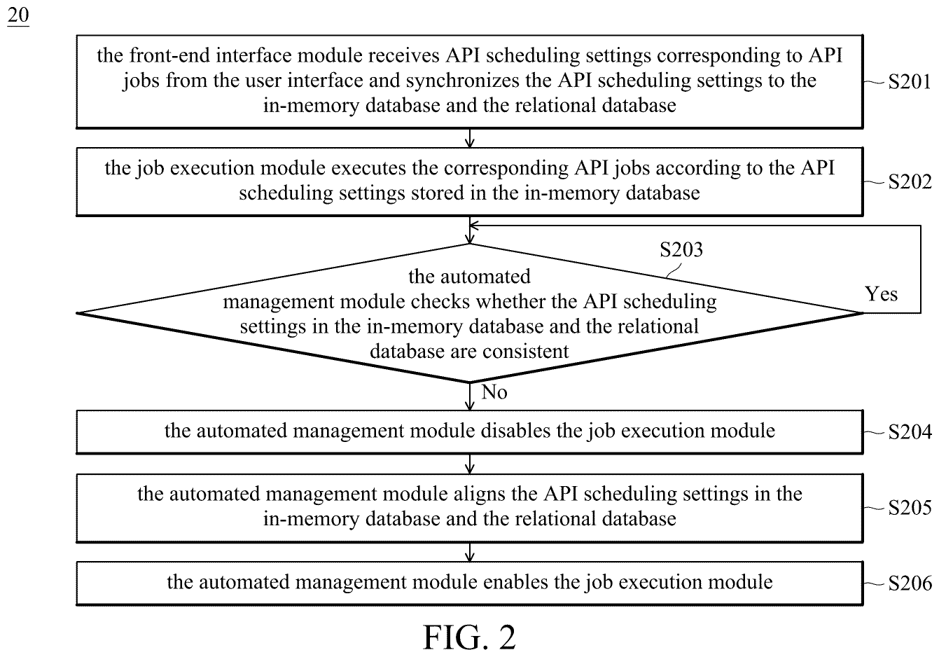

Details regarding the operation of the API scheduling management system 10, along with the API scheduling management method implemented by the system, will be elaborated below with reference to FIG. 2.

FIG. 2 is a flow diagram of an API scheduling management method 20, according to an embodiment of the present disclosure. As shown in FIG. 2, the API scheduling management method 20 includes steps S201 to S206. Since the execution entities and related components of each step are illustrated in FIG. 1, it is recommended to refer to both FIG. 1 and FIG. 2 for a clearer understanding of the embodiments of the present disclosure.

In step S201, the front-end interface module 101 receives API scheduling settings corresponding to API jobs from the user interface 110 and synchronizes the API scheduling settings to the in-memory database 102 and the relational database 103.

The user interface 110 is provided by the front-end interface module 101 and serves as a medium for interaction and information exchange between the API scheduling management system 10 and the user. The user interface 110 may be implemented as a graphical user interface (GUI), a command line interface (CLI), or a voice user interface (VUI), but the present disclosure is not limited thereto. Through the user interface 110, users can configure the API scheduling settings corresponding to API jobs to be executed on schedule. These settings may include the names, parameters, types (e.g., GET, POST, PUT, DELETE), and/or scheduling times (e.g., 1:00 AM every Monday, 7:00 AM daily, or 0 and 30 minutes past every hour) of the API jobs.

It should be noted that the API scheduling settings received in step S201 may pertain to a single API job or to a sequence of multiple API jobs. For instance, an API job may be configured to check whether employees have left the company by querying the Active Directory (AD) to obtain a list of departing employees. Subsequently, another API job may be configured to cancel the Copilot accounts of the departing employees to prevent duplicate billing.

It should be understood that although the front-end interface module 101 synchronizes the API scheduling settings to both the in-memory database 102 and the relational database 103, discrepancies may still occur due to factors such as network latency, system failures, or write failures during the synchronization process, even though the settings are theoretically expected to remain consistent. Therefore, in subsequent steps, the consistency of API scheduling settings between the two databases will be monitored.

In step S202, the job execution module 104 executes the corresponding API jobs according to the API scheduling settings stored in the in-memory database 102.

In step S203, the automated management module 105 checks whether the API scheduling settings in the in-memory database 102 and the relational database 103 are consistent. If discrepancies are detected, step S204 is performed. If the API scheduling settings in the in-memory database 102 and the relational database 103 are consistent, the system waits for a predetermined time interval before proceeding to the next round of checks.

Step S203 may be performed periodically, for example, every 5 minutes or 10 minutes. The time interval can be determined based on actual needs, and the present disclosure is not limited thereto. Besides scheduled periodic checks, step S203 can also be event-driven. For instance, the user interface 110 may provide a function allowing users to manually trigger real-time monitoring.

In step S204, the automated management module 105 disables the job execution module 104. The purpose of this step is to prevent the continuation of API job execution when the API scheduling settings in the in-memory database 102 and the relational database 103 are inconsistent, thereby avoiding unexpected errors or duplicate executions. Additionally, disabling the job execution module 104 helps ensure system stability during the subsequent data synchronization and correction steps, preventing abnormal behaviors.

In step S205, the automated management module 105 aligns the API scheduling settings in the in-memory database 102 and the relational database 103 to make them consistent.

In step S206, the automated management module 105 enables the job execution module 104. At this point, the API scheduling settings in the in-memory database 102 and the relational database 103 are consistent, allowing the job execution module 104 to resume normal operation.

In an embodiment, if inconsistencies are detected between the API scheduling settings in the in-memory database 102 and the relational database 103 during step S203, the automated management module is further configured to send an alert notification to the system administrator. The alert notification can be sent through various channels, such as email, short message service (SMS), and/or notification messages from instant messaging software (e.g., Slack, Microsoft Teams), ensuring that the system administrator can receive relevant information in a timely manner. The content of the alert notification may include detailed information about the inconsistent data, a timestamp of the anomaly, and/or an overview of subsequent steps (e.g., steps S204-S206) for addressing the issue, but the present disclosure is not limited thereto.

In an embodiment, the relational database 103 stores API scheduling settings through an API table and a scheduling table that are associated with each other. The API table consists of multiple fields and may include the API identifier (ID), API name, the user ID of the creator of the API job, and/or other configuration data related to the API job, but the present disclosure is not limited thereto. The scheduling table also consists of multiple fields and may include the scheduling ID, scheduling settings, and/or other configuration data related to scheduling (hereinafter referred to as “scheduling data”), but the present disclosure is not limited thereto. The API table and the scheduling table require at least one common field, referred to as a primary key and a foreign key, respectively, to establish a relationship between the two tables and facilitate queries. In an exemplary implementation, the API ID can be used as the common field, but the present disclosure is not limited thereto.

On the other hand, in this embodiment, the in-memory database 102 stores API scheduling settings using key-value pairs. Each key-value pair includes an index key for rapid querying and comparison. Accordingly, the automated management module 105 can efficiently check whether the API scheduling settings in the in-memory database 102 and the relational database 103 are consistent by comparing the aforementioned scheduling table with the index keys, without the need for a comprehensive comparison of the entire database.

In an embodiment, the scheduling table stores scheduling data corresponding to API jobs. Correspondingly, the index keys also include scheduling data corresponding to API jobs. Therefore, the automated management module 105 can check the consistency of API scheduling settings by comparing the scheduling data, without the need to compare the complete API scheduling settings.

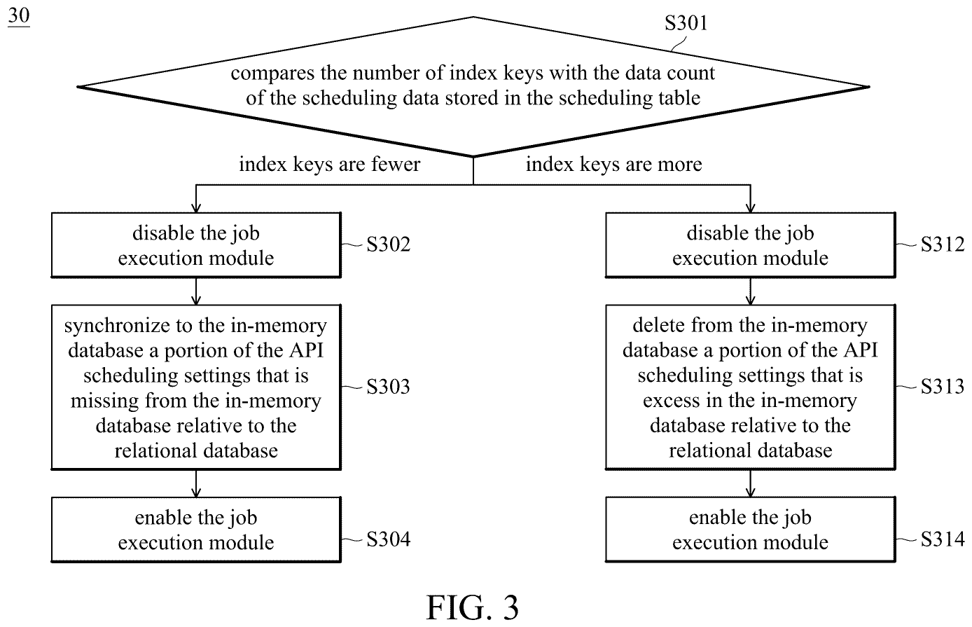

FIG. 3 is a flow diagram of an automated monitoring and recovery method 30 implemented by the automated management module 105 according to an embodiment of the present disclosure. As shown in FIG. 3, the automated management module 105 executes steps S301 to S304 and S312 to S314 to achieve automated monitoring and recovery for API jobs. Similarly, since the components involved in each step are illustrated in FIG. 1, it is recommended to refer to both FIG. 1 and FIG. 3 for a clearer understanding of the embodiments of the present disclosure.

In step S301, the automated management module 105 compares the number of index keys with the data count of scheduling data stored in the scheduling table. If the number of index keys is less than the data count of scheduling data stored in the scheduling table, step S302 is performed. If the number of index keys is greater than the data count of scheduling data stored in the scheduling table, step S312 is performed.

In step S302, the automated management module 105 disables the job execution module 104. The purpose of this step is the same as that of step S204 and will not be repeated here.

In step S303, the automated management module 105 synchronizes to the in-memory database 102 a portion of the API scheduling settings that is missing from the in-memory database 102 relative to the relational database 103. For instance, if the automated management module 105 detects that the index keys in the in-memory database 102 are missing scheduling ID “125” compared to the scheduling table in the relational database 103, the API scheduling settings corresponding to scheduling ID “125” are synchronized from the relational database 103 to the in-memory database 102.

In step S304, the automated management module 105 enables the job execution module 104. At this point, the API scheduling settings in the in-memory database 102 and the relational database 103 are consistent, allowing the job execution module 104 to resume normal operation.

In step S312, the automated management module 105 disables the job execution module 104. The purpose of this step is the same as that of step S204 and will not be repeated here.

In step S313, the automated management module 105 deletes from the in-memory database 102 a portion of the API scheduling settings that is excess in the in-memory database 102 relative to the relational database 103. For instance, if the automated management module 105 detects that the index keys in the in-memory database 102 include an excess scheduling ID “253” compared to the scheduling table in the relational database 103, the API scheduling settings corresponding to scheduling ID “253” are deleted from the in-memory database 102.

In step S314, the automated management module 105 enables the job execution module 104. At this point, the API scheduling settings in the in-memory database 102 and the relational database 103 are consistent, allowing the job execution module 104 to resume normal operation.

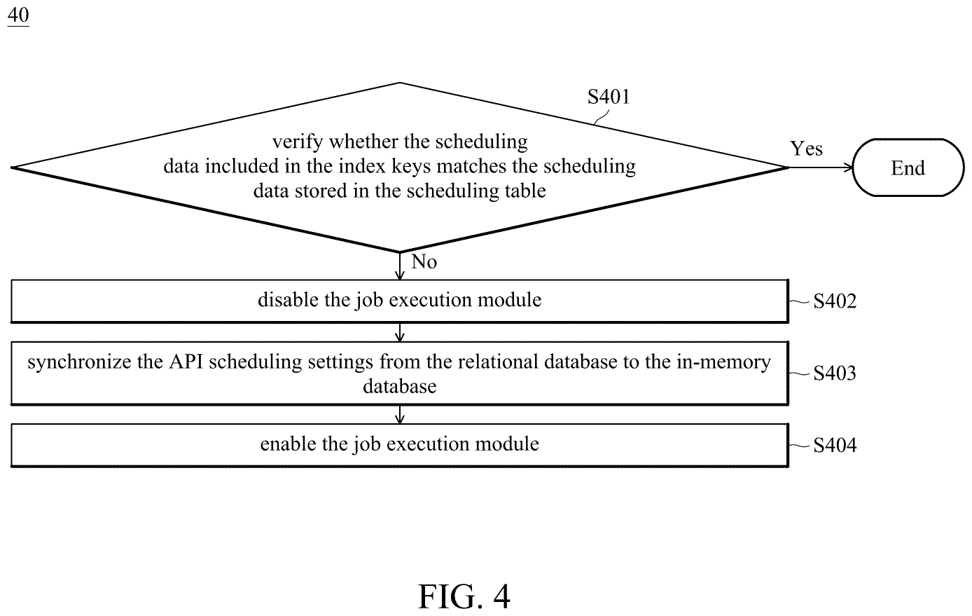

FIG. 4 illustrates additional steps of the automated monitoring and recovery method executed by the automated management module 105, according to a further embodiment of the present disclosure. As shown in FIG. 4, when the number of index keys is found to be equal to the data count of scheduling data stored in the scheduling table, the automated management module 105 further performs steps S401 to S404 to achieve more comprehensive monitoring. Similarly, since the components involved in each step are illustrated in FIG. 1, it is recommended to refer to both FIG. 1 and FIG. 4 for a clearer understanding of the embodiments of the present disclosure.

In step S401, the automated management module 105 verifies whether the scheduling data included in the index keys matches the scheduling data stored in the scheduling table. For instance, suppose the number of the index keys and the data count of the scheduling table is the same, but the index keys contain scheduling ID “327” which is not present in the scheduling table, while the scheduling table contains scheduling ID “136” which is not present in the index keys. This indicates an error in the API scheduling settings in the in-memory database 102. If such an inconsistency between the scheduling data included in the index keys and the scheduling data stored in the scheduling table is detected, step S402 is performed. If the scheduling data included in the index keys is consistent with the scheduling data stored in the scheduling table, the check is concluded.

In step S402, the automated management module 105 disables the job execution module 104. The purpose of this step is the same as that of step S204 and will not be repeated here.

In step S403, the automated management module 105 synchronizes the API scheduling settings from the relational database 103 to the in-memory database 102.

In step S404, the automated management module 105 enables the job execution module 104. At this point, the API scheduling settings in the in-memory database 102 and the relational database 103 are consistent, allowing the job execution module 104 to resume normal operation.

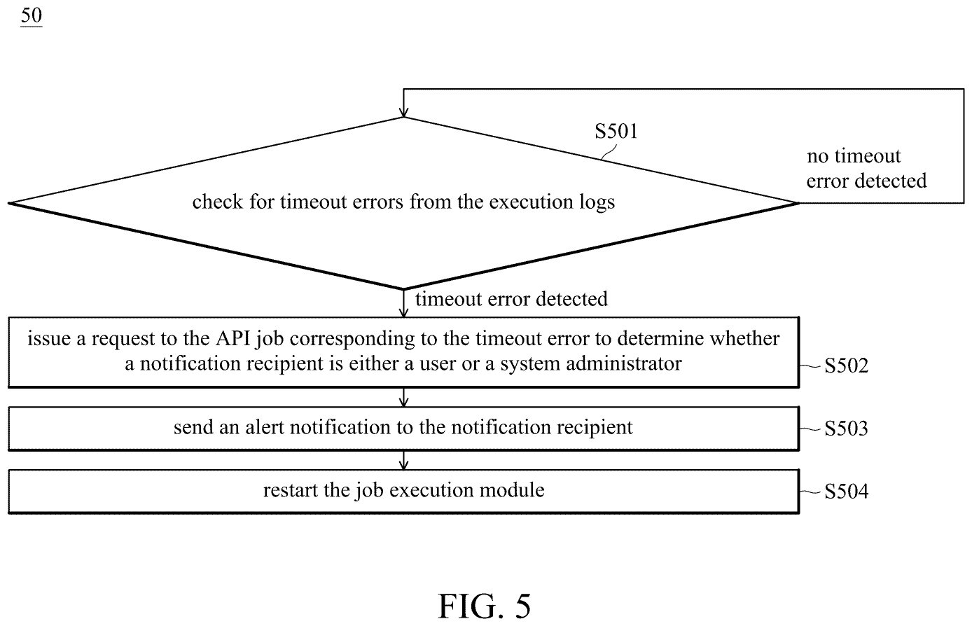

FIG. 5 is a flow diagram of an automated monitoring and recovery method 50 implemented by the automated management module 105, according to another embodiment of the present disclosure. As shown in FIG. 5, the automated management module 105 executes steps S501 to S504 to achieve automated monitoring and recovery for API jobs. Similarly, since the components involved in each step are illustrated in FIG. 1, it is recommended to refer to both FIG. 1 and FIG. 5 for a clearer understanding of the embodiments of the present disclosure.

It should be noted that, in this embodiment, the job execution module 104 stores the execution logs generated by executing API jobs in the document database 120. Additionally, it should be appreciated that the automated monitoring and recovery method 50 shown in FIG. 5 and the automated monitoring and recovery method 30 shown in FIG. 3 can be implemented independently or in combination.

In step S501, the automated management module 105 checks for timeout errors from the execution logs. A timeout error indicates that its corresponding API job has exceeded the predetermined execution time, such as 10 minutes. If a timeout error is detected, step S502 is performed. If no timeout error is detected, the system waits for a predetermined time interval before proceeding to the next round of detection.

In step S502, the automated management module 105 issues a request to the API job corresponding to the timeout error to determine whether a notification recipient is a user or a system administrator. For instance, if the response to the request for the API job corresponding to the timeout error indicates that the job cannot be executed or has encountered an anomaly, this is probably result from user misconfiguration (e.g., incorrect API parameters, unexpected data formats, or invalid authentication information), therefore the notification recipient is set to the user. On the other hand, if the response indicates that the job could not be completed due to internal system issues, such as connection timeouts, insufficient resources, or service crashes related to the job execution module 104, the notification recipient is set to the system administrator.

In step S503, the automated management module 105 sends an alert notification to the notification recipient. Specifically, if the notification recipient determined in step S502 is the user, the alert notification is sent to the user. Conversely, if the notification recipient is determined to be the system administrator, the alert notification is sent to the system administrator.

In step S504, the automated management module 105 restarts the job execution module.

The API scheduling management solution provided by the embodiments of the present disclosure achieves automated anomaly monitoring and recovery. This not only reduces the need for manual intervention but also ensures the robustness of API workflows.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An application programming interface (API) scheduling management system, comprising:
an in-memory database;
a relational database;
a front-end interface module, configured to receive API scheduling settings corresponding to one or more API jobs from a user interface, and to synchronize the API scheduling settings to the in-memory database and the relational database;
a job execution module, configured to execute the corresponding one or more API jobs according to the API scheduling settings stored in the in-memory database; and
an automated management module, configured to check whether the API scheduling settings in the in-memory database and the relational database are consistent;
wherein, in response to detecting an inconsistency between the API scheduling settings in the in-memory database and the relational database, the automated management module is further configured to disable the job execution module, align the API scheduling settings in the in-memory database and the relational database, and enable the job execution module.

2. The API scheduling management system as claimed in claim 1, wherein the relational database is configured to store the API scheduling settings through an API table and a scheduling table that are associated with each other;
wherein the in-memory database is configured to store the API scheduling settings using key-value pairs, wherein each of the key-value pairs includes an index key;
wherein the automated management module is configured to check whether the API scheduling settings in the in-memory database and the relational database are consistent by comparing the scheduling table with the index keys; and
wherein the scheduling table is used to store scheduling data corresponding to the one or more API jobs, and the index keys further include the scheduling data corresponding to the one or more API jobs.

3. The API scheduling management system as claimed in claim 2, wherein the automated management module is further configured to compare a number of the index keys with a data count of the scheduling data stored in the scheduling table;
wherein, in response to detecting that the number of the index keys is less than the data count of the scheduling data stored in the scheduling table, the automated management module is further configured to disable the job execution module, synchronize to the in-memory database a portion of the API scheduling settings that is missing from the in-memory database relative to the relational database, and enable the job execution module; and
wherein, in response to detecting that the number of the index keys are greater than the data count of the scheduling data stored in the scheduling table, the automated management module is further configured to disable the job execution module, delete from the in-memory database a portion of the API scheduling settings that is excess in the in-memory database relative to the relational database, and enable the job execution module.

4. The API scheduling management system as claimed in claim 3, wherein, in response to detecting that the quantity of the index keys is equal to the data count of scheduling data stored in the scheduling table, the automated management module is further configured to verify whether the scheduling data included in the index keys matches the scheduling data stored in the scheduling table; and
wherein, in response to detecting that the scheduling data included in the index keys does not match the scheduling data stored in the scheduling table, the automated management module is further configured to disable the job execution module, synchronize the API scheduling settings from the relational database to the in-memory database, and enable the job execution module.

5. The API scheduling management system as claimed in claim 1, further comprising a document database;
wherein the job execution module is further configured to store execution logs generated by executing the one or more API jobs in the document database;
wherein the automated management module is further configured to check for a timeout error from the execution logs, wherein the timeout error corresponds to one of the one or more API jobs;
wherein the automated management module is further configured to issue a request to the API job corresponding to the timeout error to determine whether a notification recipient is either a user or a system administrator, in response to detecting the timeout error; and
wherein the automated management module is further configured to send an alert notification to the notification recipient, and restart the job execution module.

6. A method for application programming interface (API) scheduling management, carried out by one or more computer devices, comprising following steps:
by a front-end interface module, receiving API scheduling settings corresponding to one or more API jobs from a user interface, and synchronizing the API scheduling settings to an in-memory database and a relational database;
by a job execution module, executing the corresponding one or more API jobs according to the API scheduling settings stored in the in-memory database;
by an automated management module, checking whether the API scheduling settings in the in-memory database and the relational database are consistent; and
by the automated management module, in response to detecting an inconsistency between the API scheduling settings in the in-memory database and the relational database, disabling the job execution module, aligning the API scheduling settings between the in-memory database and the relational database, and enabling the job execution module.

7. The API scheduling management method as claimed in claim 6, wherein the relational database stores the API scheduling settings through an API table and a scheduling table that are associated with each other;
wherein the in-memory database stores the API scheduling settings using key-value pairs, wherein each of the key-value pairs includes an index key;
wherein the step of checking whether the API scheduling settings in the in-memory database and the relational database are consistent further comprises comparing the scheduling table with the index keys; and
wherein the scheduling table is used to store scheduling data corresponding to the one or more API jobs, and the index keys further include the scheduling data corresponding to the one or more API jobs.

8. The API scheduling management method as claimed in claim 7, wherein steps executed by the automated management module further comprises:
comparing a number of the index keys with a data count of the scheduling data stored in the scheduling table;
in response to detecting that the number of the index keys is less than the data count of the scheduling data stored in the scheduling table, disabling the job execution module, synchronizing to the in-memory database a portion of the API scheduling settings that is missing from the in-memory database relative to the relational database, and enabling the job execution module;
in response to detecting that the number of the index keys are greater than the data count of the scheduling data stored in the scheduling table, disabling the job execution module, deleting from the in-memory database a portion of the API scheduling settings that is excess in the in-memory database relative to the relational database, and enabling the job execution module.

9. The API scheduling management method as claimed in claim 8, wherein steps executed by the automated management module further comprises:
in response to detecting that the quantity of the index keys is equal to the data count of scheduling data stored in the scheduling table, verifying whether the scheduling data included in the index keys matches the scheduling data stored in the scheduling table; and
in response to detecting that the scheduling data included in the index keys does not match the scheduling data stored in the scheduling table, disabling the job execution module, synchronizing the API scheduling settings from the relational database to the in-memory database, and enabling the job execution module.

10. The API scheduling management method as claimed in claim 6, further comprising:
by the job execution module, storing execution logs generated by executing the one or more API jobs in the document database;
wherein steps executed by the automated management module further comprises:
checking for a timeout error from the execution logs, wherein the timeout error corresponds to one of the one or more API jobs;
issuing a request to the API job corresponding to the timeout error to determine whether a notification recipient is either a user or a system administrator, in response to detecting the timeout error; and
sending an alert notification to the notification recipient, and restart the job execution module.
